(19) United States
(12) Patent Application Publication
(10) Pub. No.: US 2007/0294635 A1
(43) Pub. Date: Dec. 20, 2007

(54) Linked scrolling of side-by-side content

(75) Inventors: Richard S. Craddock, San Francisco, CA (US); Rodrigo A. Lagos, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/454,453

(22) Filed: Jun. 15, 2006

(51) Int. Cl. G06F 3/048

(52) U.S. Cl. 715/784

(57) ABSTRACT

Methods are disclosed for linked and intelligent scrolling through a plurality of containing elements. The methods include a software scrollbar display engine, a software resizing engine and a software scrolling engine for affecting linked scrolling of the plurality of containing elements.

### BACKGROUND

Web-based application programs, such as web portals, search engines and email clients, currently present users with a graphical user interface including content from a wide array of different sources. For example, a typical web-based application program may present a user with a webpage including content which the user has selected (email, search results, etc.), as well as one or more advertisements presented to the user from sponsors of the webpage. When defining the webpage layout, using for example Cascading Style Sheets, containing elements may be defined having given dimensions and locations on the page. The content and advertisements may then be set up in the respective containing elements. A containing element is an example of a graphical object, and may be a box containing content or another containing element.

The content defined within a containing elements may be text and/or graphics. Containing elements may often be presented vertically, side-by-side, on a webpage, such as shown for example in prior art FIG. 1. Prior art FIG. 1 illustrates a graphical user interface 20 including a first containing element 22 along side a second containing element 24, each of which is shown with shading in FIG. 1. It is known that the content of one or both of containing elements 22 and 24 may extend beyond the vertical or horizontal borders of the containing element, such as shown in FIG. 1. In such instances, the browser would ordinarily include vertical scrollbars, such as scrollbar 26 for containing element 22 and scrollbar 28 for containing element 24.

One shortcoming of the screen layout shown in FIG. 1 is that the plurality of vertical scrollbars take up valuable real estate on the graphical user interface. One potential solution is to have the two containing elements scroll together with a single scrollbar. However, it is known that one or both of the containing elements 22, 24 may be set up to have a user-defined, variable length, and thus conventionally, have not been linked together for operation by a single scrollbar. Moreover, if the two containing elements were scrolled together with a single scrollbar, scrolling to the bottom of one containing element may completely scroll past the content of the second containing element. This is particularly disadvantageous where the second containing element may include an advertisement that the sponsor would like to be visible to users as much as possible.

It is also known that a containing element may be set up to include a nested, inner containing element. As indicated in prior art FIG. 2, an inner containing element 22a may be larger than its containing element 22. A further problem with conventional browser user interfaces is that, where an inner containing element extends beyond the boundaries of the outer containing element, the inner containing element may wind up with hidden scrollbars where content of the inner containing element exceeds the borders of the inner containing element. For example, in FIG. 2, inner containing element 22a includes content which extends beyond the horizontal boundaries of the inner containing element 22a. The browser would thus ordinarily include a horizontal scrollbar 30 at the bottom of the inner containing element 22a. However, the horizontal scrollbar 30 of inner containing element 22a is not visible on the interface 20 unless brought into view upon actuation of the vertical scrollbar 26 to show the bottom of the inner containing element. Thus, a user may be unaware that there is additional content in the inner containing element 22a beyond the vertical edge of the outer containing element 22.

### SUMMARY

Embodiments of the present system in general relate to methods for linked and intelligent scrolling through containing elements. The method may be implemented in a software application program such as JavaScript and Cascading Style Sheets for interpretation by a conventional browser. The software may include a scrollbar display engine, a resizing engine and a scrolling engine, each of which interact with a browser to affect linked scrolling of first and second containing elements.

The scrollbar display engine initially suppresses scrollbars that a browser would ordinarily display for the first and second containing elements where they include content extending beyond the element boundaries. In place of the conventional vertical scrollbars, the scrollbar display engine generates and displays a managed scrollbar. The managed scrollbar includes a managed scrollbar element and shadow element within the scrollbar element. The managed scrollbar element is defined with a display height equal to the display height of the contained elements. The shadow element is assigned a height equal to the height of the content in the containing element having the longer content.

As the height of the shadow element exceeds the height of the managed scrollbar element, the browser may assign a scrollbar within managed scrollbar element as is known in the art, allowing a user to scroll down across the entire height of the shadow element. Thus, the managed scrollbar displayed by the scrollbar display engine is a containing element having a scrollbar capable of scrolling through content equal to the height of the longer content from within the first and second containing elements.

The sizing engine sets the pixel width of the containing elements upon a resizing of one or more of the containing elements displayed on the user interface. One of the first and second containing elements may have a fixed pixel width, and the other of the first and second containing elements may have a variable pixel width. Moreover, the user interface may include a plurality of side-by-side, variable width, containing elements in addition to the first and second containing elements. When one of the variable width containing elements is resized, the resize engine calculates the width of the remaining containing elements. When calculating the width of N containing elements upon a resize of one, the sum of the pixel widths for N−1 containing elements is determined, and the remaining containing element is given a pixel width of the total width of the N containing elements minus the width of the N−1 containing elements. In resizing a given containing element, the resizing engine may also determine if the element includes a fixed-width object. If so, the resizing engine may include a horizontal scroll bar in the event the resized containing element is narrower than the fixed-width object within that containing element.

The present system further includes a scrolling engine for controlling the scroll of the first and second containing elements. In general, the scrolling engine enables a user to scroll the first and second containing elements together via the managed scrollbar (or other known scroll event) until the content within the shorter content containing element reaches its bottom edge. When the first and second containing elements scroll sufficiently downward to the point where the bottom of the shorter content containing element is reached, the shorter content containing element will be pinned (i.e., held stationary) while the longer content containing element continues to scroll upward or downward on an upward or downward scroll event. However, when the first and second containing elements are near the top of their content, so that the bottom of the smaller content containing element has not been reached, the first and second containing elements will be scrolled upward or downward together in a linked fashion upon an upward or downward scroll event.

In embodiments, one of the first and second containing elements may be an advertisement. In such embodiments, the content within the advertisement may be scrolled together with the content in the other containing element until the bottom of the advertisement is reached. Thereafter, continued scrolling through the content of the other containing element may occur while the advertisement remains fixed and visible on the user interface.

Instead of having first and second linked containing elements, more than two containing elements may be linked together in further embodiments of the present system. When the bottom of the content in one of the containing elements is reached, that content may be pinned while scrolling may continue through the other containing elements.

### DESCRIPTION OF THE DRAWINGS

FIG. 1 is an illustration of a prior art user interface including a pair of side-by-side containing elements each including its own scrollbar.

FIG. 2 is an illustration of a conventional user interface including a pair of containing elements each having its own vertical scrollbar, wherein one of the containing elements further includes a nested, inner containing element having a hidden horizontal scrollbar.

FIG. 3 is a block diagram of the software according to an embodiment of the present system.

FIG. 4 is an illustration of a graphical user interface showing a plurality of linked containing elements and a managed scrollbar according to embodiments of the present system.

FIG. 5 is an illustration of a graphical user interface as in FIG. 4, and further showing the length of the content contained within the containing elements of FIG. 4.

FIG. 6 is a flowchart for generating and displaying the managed scrollbar according to embodiments of the present system.

FIG. 7 is an illustration of a graphical user interface according to embodiments of the present system.

FIG. 8 is an illustration of a graphical user interface having a resized containing element according to an embodiment of the present system.

FIG. 9 is a flowchart of the resizing engine according to embodiments of the present system.

FIG. 10 is a flowchart for displaying a horizontal scrollbar of a nested, inner containing element according to embodiments of the present system.

FIG. 11 illustrates a graphical user interface symbolically showing the scrolling of content from a pair of containing elements.

FIG. 12 is a flowchart for the scrolling engine according to embodiments of the present system.

FIG. 13 is an illustration of a graphical user interface symbolically showing the linked scrolling of a pair of containing elements according to embodiments of the present system.

FIG. 14 is an illustration of a graphical user interface symbolically showing the scrolling of a containing element while a second containing element is pinned according to embodiments of the present system.

FIG. 15 is an illustration of a graphical user interface showing the linked scrolling of a pair of containing elements according to embodiments of the present system.

FIG. 16 is an illustration of a graphical user interface showing the scrolling of a containing element while a second containing element is pinned according to embodiments of the present system.

FIG. 17 is a block diagram of hardware components on which embodiments of the present system are capable of operation.

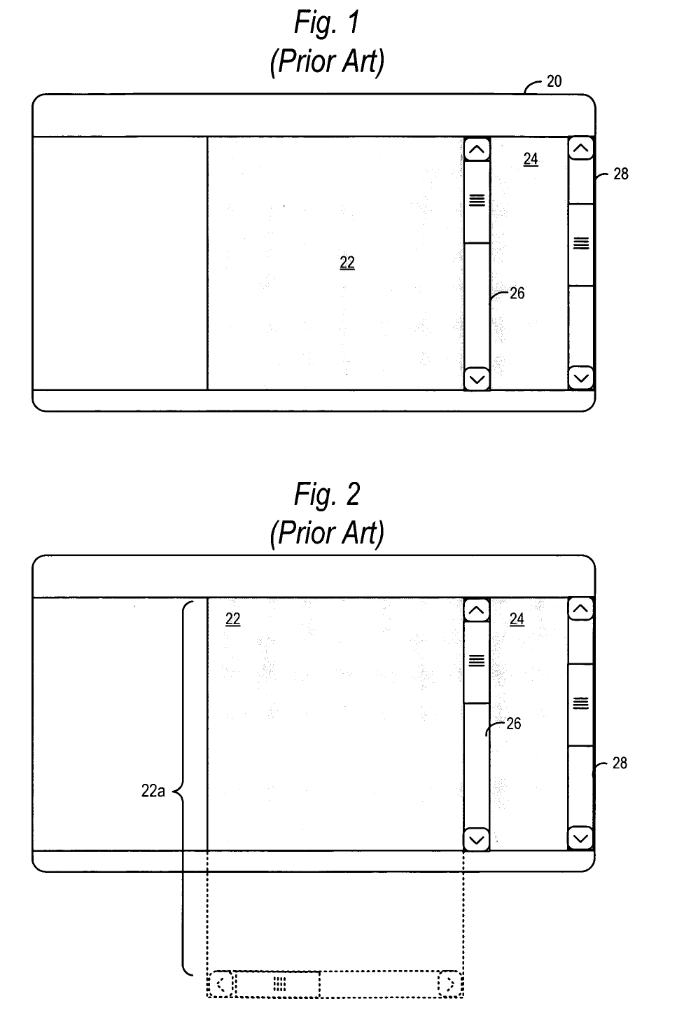

### DETAILED DESCRIPTION

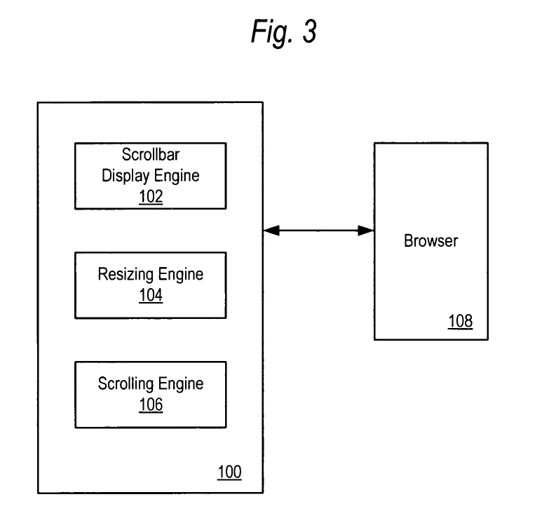

Embodiments of the present system will now be described with reference to FIGS. 3-17, which in general relate to methods for linking containing elements for vertical scrolling within the elements. Referring initially to the software block diagram of FIG. 3, the software 100 in embodiments of the present system may be implemented in JavaScript for interpretation by a conventional browser 108 using any of a variety of markup languages, including for example HTML and XHTML. The software 100 may include a scrollbar display engine 102, a resize engine 104 and a scrolling engine 106, each of which interact with browser 108 as explained hereinafter. While embodiments of the present system are explained with respect to content which may be downloaded via the Internet or other network to a client device and displayed on the device via browser 108, it is understood that the software according to the present system may be an application program capable of execution on a client device without the aid of a browser.

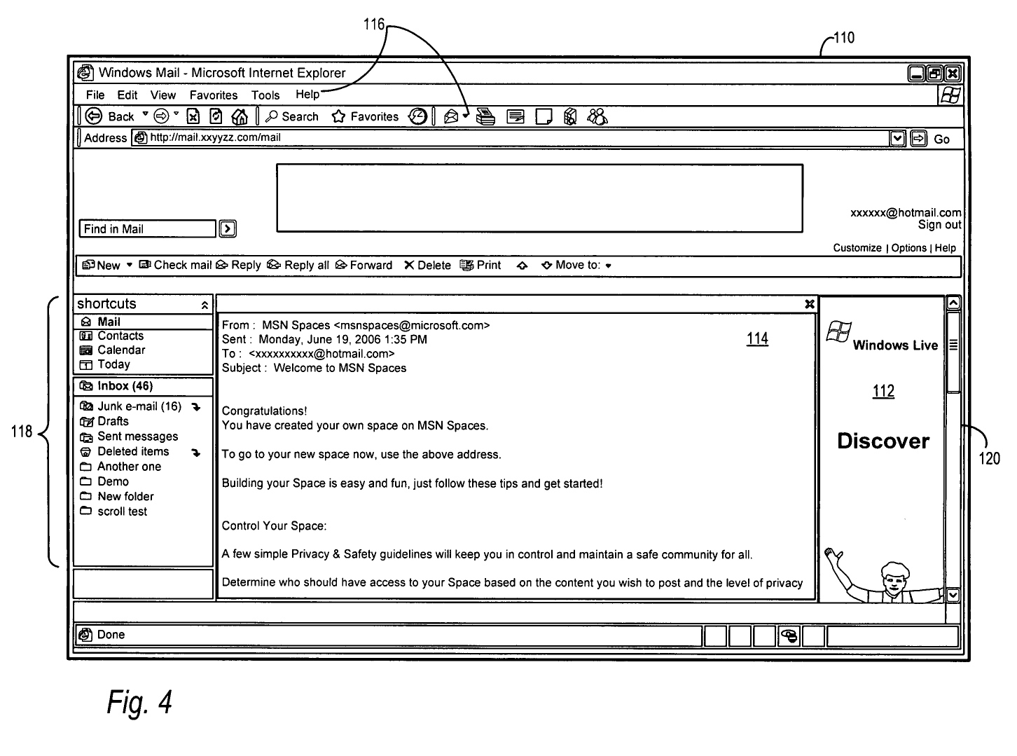

Referring now to FIG. 4, there is shown a sample graphical user interface 110 including containing elements 112 and 114 and a managed scrollbar 120 for linked scrolling through the content within containing elements 112, 114 according to embodiments of the present system. In the embodiment shown in FIG. 4, the interface 110 is for an email client, such as for example MSN Hotmail or Windows® Live Mail. In addition to containing elements 112, 114, the interface 110 may include other mail client content, such as for example browser icons 116, and mail navigation links and folder items 118. Other content is contemplated. In the embodiment shown, containing element 112 includes an advertisement, and containing element 114 includes content from a displayed email message. It is understood that containing elements 112 and/or 114 may include other content in further embodiments. Moreover, as indicated above, instead of a mail client, the present system for managed scrolling of content in a plurality of graphical windows may be included as part of a variety of software application programs.

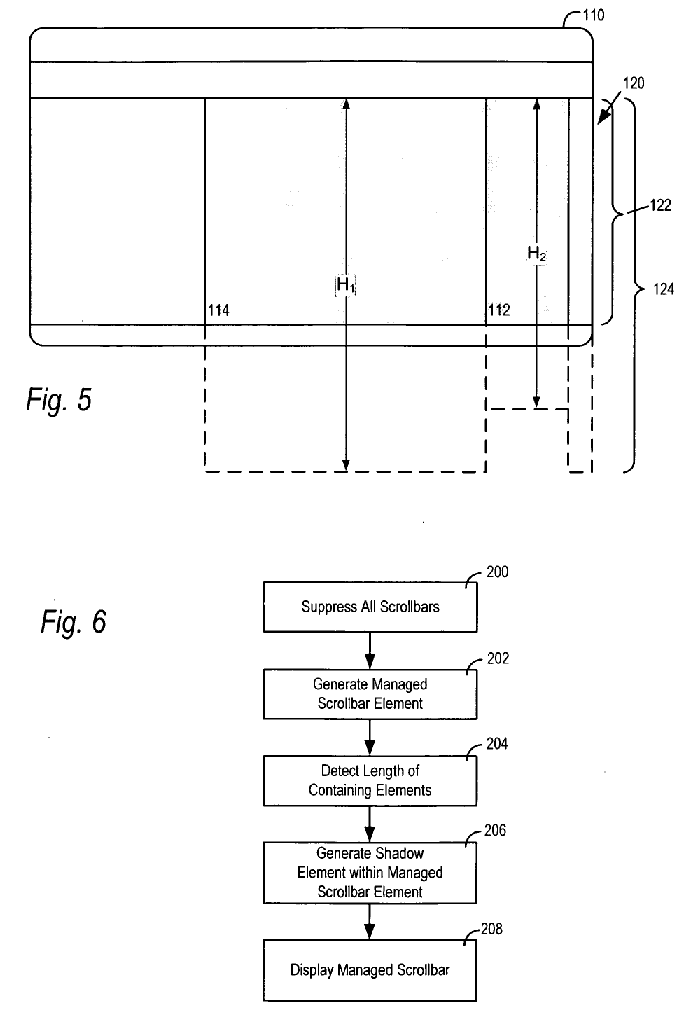

The scrollbar display engine 102 will now be explained with reference to the user interface shown in FIG. 5 and the flowchart of FIG. 6. FIG. 5 illustrates the same user interface 110 and containing elements 112 and 114 as in FIG. 4, without the actual content of FIG. 4 being shown. However, the height of the content in containing elements 114 and 112 is indicated by heights H₁ and H₂, respectively, in FIG. 5. As seen in FIG. 4 and as indicated by the shaded areas in FIG. 5, only that content appearing within the containing elements 112 and 114 is visible on interface 110, with the remaining content extending beyond the lower boundary of containing elements 112 and 114.

Ordinarily, browser 108 would include scrollbars for containing elements 112 and 114 as described in the Background section. However, referring now to the flowchart of FIG. 6, in a step 200, the scrollbar display engine 102 initially suppresses all scrollbars (vertical and horizontal) otherwise displayed on the graphical user interface 110. As indicated above, scrollbar display engine 102 may accomplish this with a JavaScript interpreted by browser 108. In alternative embodiments, merely the vertical scrollbars for containing elements 112 and 114 may be suppressed, and horizontal scrollbars may be provided at the bottom of interface 110 for containing elements 112 and/or 114 if the containing elements include content extending beyond a horizontal border.

Managed scrollbar 120 includes managed scrollbar element 122 and shadow element 124 within the scrollbar element 122. In step 202, the scrollbar display engine may generate the managed scrollbar element 122 on graphical user interface 110 as shown in FIG. 5. Managed scrollbar element 122 may be the same size as a typical scrollbar, and displayed at the edge of user interface 110 as shown in FIG. 5. It is understood that the managed scrollbar element 122 may be presented in between containing elements 112 and 114 or to the left of containing element 114 in alternative embodiments of the present system.

At step 204, the scrollbar display engine 102 acquires the height of the content (or inner containing element) for whichever has a longer content (or inner containing element) as between containing elements 112 and 114. For example, in FIG. 5, the height H₁ of the content in containing element 114 is longer than the height H₂ of the content in containing element 112. In step 206, the scrollbar display engine 102 generates the shadow element 124 resident within the managed scrollbar element 122. The height of shadow element 124 is equal to the larger content height from either containing element 112 or 114 as detected in step 204. Thus, in the embodiment shown in FIG. 5, shadow element 124 would have a height of H₁.

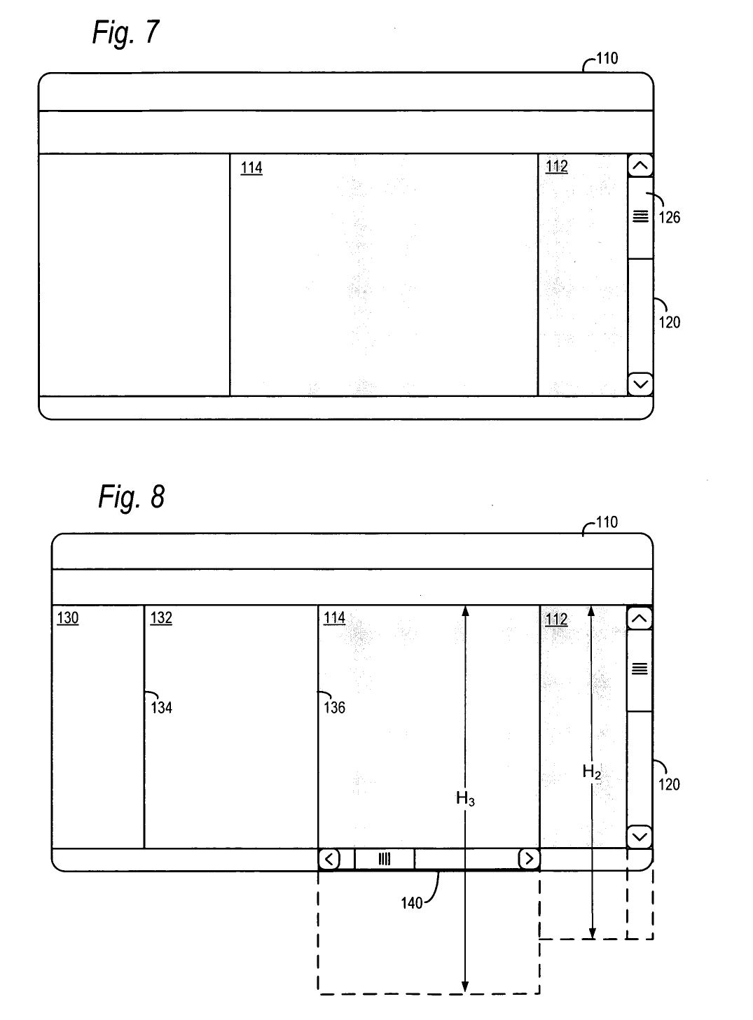

As a height of the shadow element 124 exceeds the height of the managed scrollbar element 122, browser 108 may assign a scrollbar within managed scrollbar element 122 as is known in the art, allowing a user to scroll down across the entire height of the shadow element 124. Accordingly, as shown in FIG. 7, the scrollbar display engine 102 displays the managed scrollbar 120 in step 208 having a scrollbar capable of scrolling through content equal to the height of the longer content from within the containing elements 112 and 114. As is known in the art, the longer the shadow element 124 is in relation to the managed scrollbar element 122, the shorter will be the slider 126 of managed scrollbar 120.

In the embodiments shown, the containing elements 112 and 114 have equal pixel heights. However, it is understood that the containing elements need not have the same height in alternative embodiments. In such embodiments, the height of the managed scrollbar 120 may be that of the longer containing element, though it need not be in further embodiments.

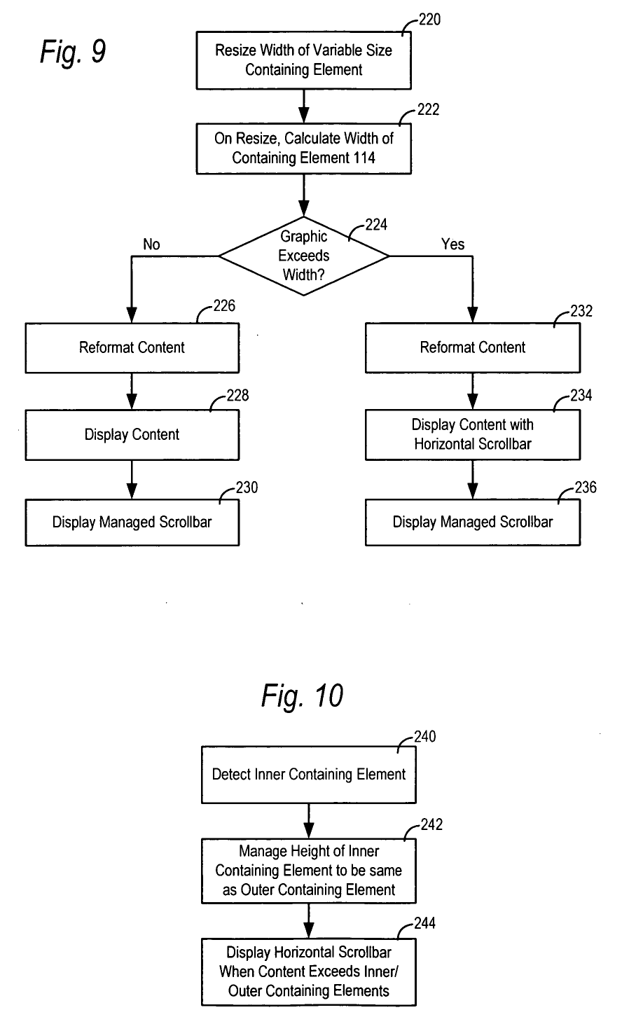

The resize engine 104 will now be described with respect to the user interface 110 shown in FIG. 8 and the flowcharts of FIGS. 9 and 10. In embodiments of the present system, containing element 114 may have a user-defined, variable width, and containing element 112 may have a fixed width. It is understood that both containing elements 112 and 114 may have fixed widths, and that both containing elements 112 and 114 may have user-defined, variable widths, in alternative embodiments of the present system.

In the embodiment of FIG. 8, graphical user interface 110 is shown including containing elements 112 and 114, and managed scrollbar 120, as described above. The interface 110 of FIG. 8 further includes two additional, variable width, containing elements 130 and 132. Though the contents of containing elements may vary greatly, in an embodiment where the graphical user interface 110 displays a mail client, the containing element 130 may display user folders (inbox, deleted, sent, etc.), and the containing element 132 may display the contents of a selected folder. Although not shown, containing elements 130 and/or 132 may include vertical and/or horizontal scrollbars conventionally controlled by browser 108. It is understood that, in addition to containing elements 112, 114, interface 110 may include more or less than two additional horizontally adjacent containing elements in further embodiments.

As is known in the art, the width of containing elements 130 or 132 may be changed by clicking and dragging on its right border, 134 or 136, respectively, in a step 220 (FIG. 9). The resize engine 104 may then calculate the width of the remaining containing elements in step 222, based on the resized pixel width of containing elements 130 and 132, and any fixed-width containing elements such as containing element 112. Thus, for example, if the border 134 were moved to resize the width of containing element 130, the resize engine would take the overall pixel width of interface 110, subtract the new pixel width of containing element 130, subtract the pixel width of containing element 132 (unchanged) and subtract the pixel width of containing element 112 (fixed) to get the resulting new pixel width of containing element 114.

Those of skill in the art will appreciate that resize engine 104 may calculate the width of the containing elements in other ways. For example, where a width of containing element 130 is increased, the resize engine 104 may follow the above steps, but leave containing element 114 unchanged and instead decrease the width of containing element 132 by subtracting the widths of the containing elements 130, 114 and 112 from the overall available width. Moreover, while the containing elements 112, 114, 130 and 132 in the above embodiment together take up the entire width of interface 110, it is understood that the containing elements may take up less than the entire width of the interface. Regardless, when calculating the width of N containing elements upon a resize of one, the sum of the pixel widths for N−1 containing elements is determined, and the remaining containing element is given a pixel width of the total width of the N containing elements minus the width of the N−1 containing elements.

In an embodiment where containing element 114 is resized after the pixel width of the remaining containing elements is determined, it may happen that containing element 114 includes graphics or other fixed-width objects which exceed the width of the new size determined for containing element 114. Thus, in step 224, the resize engine 104 checks for fixed width objects that exceed the resized width of containing element 114.

If there are no objects that exceed the resized width of the containing element 114, the content within containing element 114 is reformatted to fit within the resized containing element in step 226. For example, if the containing element 114 was made narrower, then text within containing element 114 may be reformatted to be narrower but longer (H₃). The content within containing element 114 is then displayed in step 228, and the managed scrollbar 120 is displayed in step 230. In order to display the managed scrollbar 120, the scrollbar display engine 102 again performs the steps described above with respect to the flowchart of FIG. 6, using the new height of the content within containing element 114.

If, on the other hand, there are objects that exceed the resized width of the containing element 114 in step 224, then containing element 114 is resized as described above, and a horizontal scrollbar 140 of known construction is provided by browser 108 within containing element 114. In particular, upon resizing the containing element 114, the content within containing element 114 is reformatted (accommodating at least the width of the fixed-width object) in step 232, and the reformatted content is displayed within containing element 114 with the horizontal scrollbar 140 in step 234. The managed scrollbar 120 is then constructed by the scrollbar display engine 102 and displayed in step 236.

As discussed in the Background section, when a containing element includes an inner containing element having content exceeding the boundaries of the inner containing element, this may result in a hidden scrollbar on the inner containing element below or to the side of the boundaries of the outer containing element. Accordingly, prior to the steps 228, 234 of displaying the content in the containing element 114, embodiments of the present system may execute the steps described below with respect to FIG. 10.

Where for example containing element 114 includes an inner, imbedded containing element, the inner containing element is detected in step 240 of FIG. 10. In step 242, resize engine 104 manages the height of the inner containing element so that it will be the same pixel height as outer containing element 114. As the outer containing element 114 and its inner containing element are now the same height, to the extent content exists which extends beyond the horizontal boundaries of either outer containing element 114 or its inner containing element, the horizontal scrollbar 140 will be displayed along the bottom edge of the containing element 114 in step 234 described above. Thus, the problem of hidden scrollbars is alleviated.

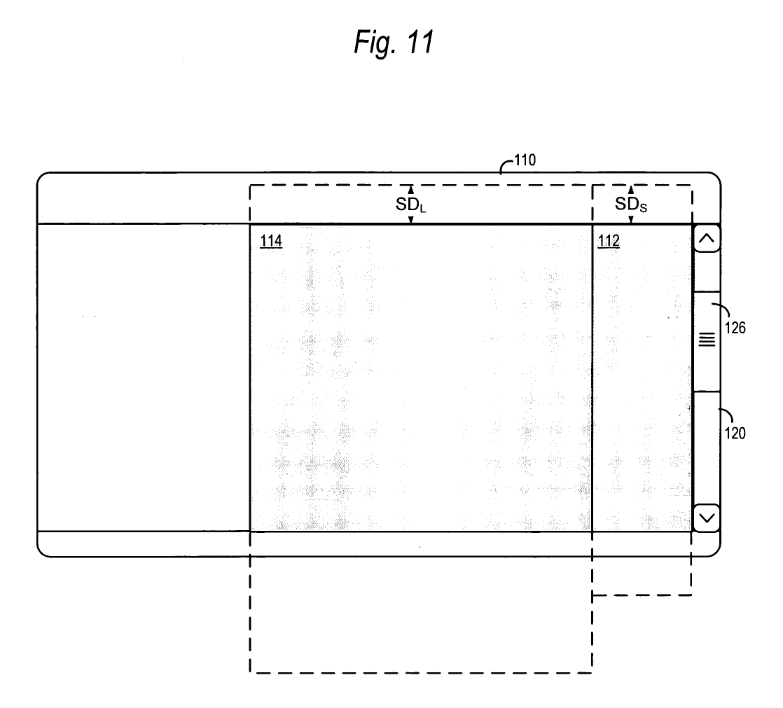

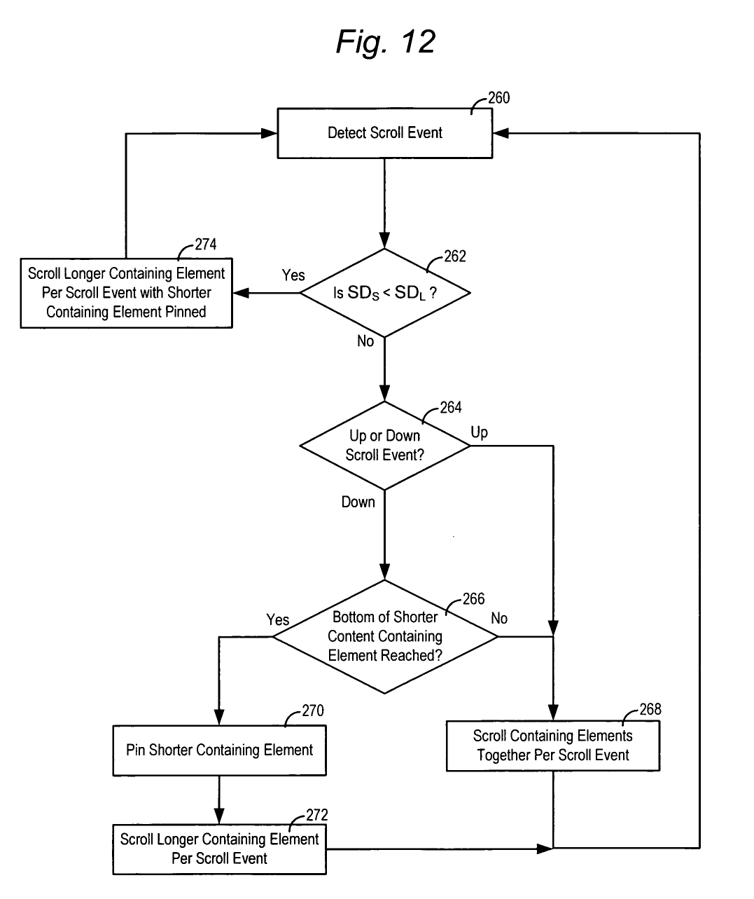

Scrolling engine 106 for controlling the scroll of containing elements 112 and 114 according to the present system will now be explained with a reference to the graphical user interface shown in FIGS. 11, 13 and 14, and the flowchart of FIG. 12. In general, scrolling engine 106 enables a user to scroll containing elements 112 and 114 together via the managed scrollbar 120 (or other scroll event described below) until the content within the shorter content containing element reaches its bottom edge. Thereafter, continued actuation of managed scrollbar 120 (or other scroll event) continues to scroll through the longer content containing element while the shorter content containing element remains pinned (i.e., stationary within the user interface).

In embodiments of the present system, any scroll event which conventionally scrolls one of the containing elements 112, 114 would affect linked scrolling of the containing elements until one of the elements is pinned. Such scroll events include, but are not limited to:
Click and drag on the managed scrollbar
Click top/bottom arrow in managed scrollbar
Keyboard arrow up or down
Mouse wheel
Scroll up/down with mouse or keyboard when cursor is positioned in one of the containing elements
Scroll while selecting text in a containing element
Keyboard, PageUp, PageDown, Home, End
Keyboard, Spacebar.

Referring initially to FIG. 11, there is shown graphical user interface 110 including containing elements 112 and 114 and managed scrollbar 120. In FIG. 11, slider 126 of managed scrollbar 120 has been actuated downward from its uppermost position (either by actuation of slider 126 or some other scroll event). In the embodiment shown in FIG. 11, the content within containing element 114 is longer than the content included within containing element 112. As a user scrolls through the content in containing elements 112, 114, the content will move upward or downward in the respective containing elements by a scrolling distance SD_{L} (for the longer content containing element—element 114 in this example), and a scrolling distance SD_{S} (for the shorter content containing element—element 112 in this example). Upon an initial downward scroll, the two containing elements will scroll together, and the scrolling distances SD_{L} and SD_{S} will remain equal to each other, until the smaller content containing element gets pinned as explained with reference to the flowchart of FIG. 12.

The scrolling engine 106 detects a scroll event in step 260. A scroll event may be through actuation of the managed scrollbar 120 or through any known action for scrolling upward or downward through content, some of which are mentioned above. In step 262, the scrolling engine detects whether the scrolling distance SD_{S} is less than the scrolling distance SD_{L}. Initially, prior to any downward scroll, when the content of containing elements 112 and 114 are at the uppermost position, SD_{L}=SD_{S}=zero.

If SD_{S} is not less than SD_{L}, the scrolling engine 106 proceeds to step 264. SD_{S} will for example not be less than SD_{L} at a point prior to any scrolling taking place, or upon a linked, equal scrolling of the content within both containing elements 112 and 114 as explained hereinafter.

The scrolling engine 106 may handle upward and downward scroll events slightly differently. Therefore, if the scrolling engine 106 detects a downward scroll in step 264 (as in an initial downward scroll from the top of containing elements 112 and 114), the scrolling engine proceeds to a step 266.

In step 266, the scrolling engine 106 determines whether the containing element having the shorter content has reached the bottom of that content. Upon an initial downward scroll from the top of the content, the bottom of the shorter content will not yet have been reached, and the scrolling engine 106 performs a step 268 of scrolling the containing elements 112 and 114 in a linked fashion according to the scroll event.

In particular, in step 268, the scrolling engine 106 links containing elements 112 and 114 together so as to scroll at the same rate and the same distance, depending on the magnitude and rate of the scroll event. Thus, in step 268, if the browser detects actuation of slider 126 (or mouse click on the down arrow) in managed scrollbar 120, the software of the present system affects an equal movement of both containing elements 112 and 114 in unison with slider 126. Similarly, in step 268, if the browser detects a scroll event in one of the containing elements 112 or 114, the scrolling engine 106 affects an equal movement of both containing elements 112 and 114. Moreover, in this latter case, in addition to scrolling both containing elements 112, 114, the software would similarly affect a corresponding movement of the slider 126 of managed scrollbar 120.

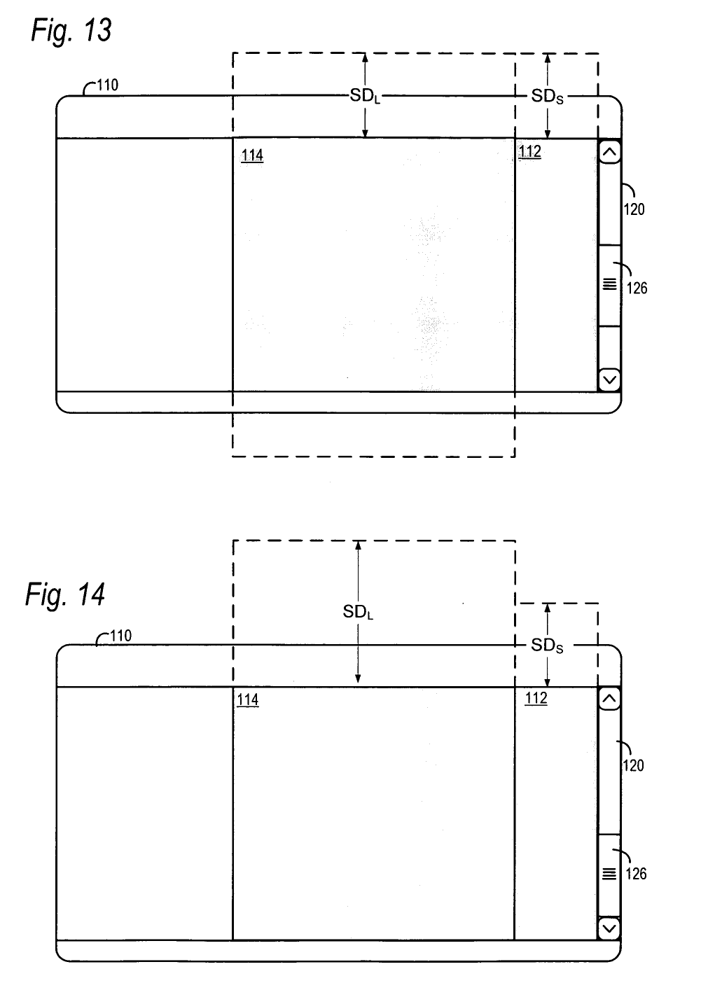

After step 268, the scrolling engine 106 returns to step 260 to detect a further or continued scroll event. Upon a continued downward scroll with containing elements 112 and 114 linked together and moving in unison (as indicated in FIG. 11), the scrolling engine will cycle through steps 260, 262 and 264 until the shorter content containing element reaches the bottom of its content (as indicated in FIG. 13). This event is detected in step 266. At that point, the shorter content containing element gets pinned in step 270. That is, upon a continued scrolling event, the scrolling engine 106 freezes, or pins, the position of the content within the shorter content containing element, and the bottom of the content remains fixed and visible at the bottom of its containing element.

With the shorter content containing element pinned, the scrolling engine 106 continues to scroll the longer content containing element per the scroll event in step 272. Thus, for example, if the containing elements 112 and 114 were scrolled together until the content in containing element 112 reaches its bottom, further downward actuation of slider 126 on managed scrollbar 120 would affect further downward scroll through the content in containing element 114. During this scrolling, the content within containing element 112 remains pinned. Similarly, a mouse or keyboard event within containing element 114 would affect continued scroll through the content in containing element 114 while the content of containing element 112 remained pinned. After scrolling the longer content containing element in step 272, the scrolling engine 106 returns to step 260 to detect further or continued scrolling events.

FIG. 14 illustrates the case where the scrolling engine has scrolled containing element 114 while containing element 112 is pinned. Accordingly, as seen in FIG. 14, SD_{S} has become less than SD_{L}. As long as the scrolling distance SD_{S} is smaller than the scrolling distance SD_{L} in step 262, the scrolling engine will branch to step 274. In step 274, the scrolling engine affects scrolling of the content in the longer content containing element per a scroll event, while the shorter content containing element remains pinned. This is true for an upward or downward scroll event. Thus, as long as the content in containing element 114 has been scrolled downward while the content in containing element 112 is pinned, an upward or downward scroll event will affect a similar upward or downward scroll of the content in containing element 114.

While the shorter content containing element is pinned, it may happen that the longer content containing element is scrolled upward (decreasing the scroll distance SD_{L}) to the point where SD_{L} again equals the scroll distance SD_{S}. This is again the situation shown in FIG. 13. At that point, SD_{S} is no longer less than SD_{L} in step 262, and the scrolling engine proceeds to step 264. Upon this initial upward scroll event, scrolling engine 106 will branch from step 264 to step 268 directly, whereupon the scrolling engine 106 again scrolls the two containing elements 112 and 114 together in a linked fashion. While the two containing elements 112 and 114 are linked and scrolled together, should a downward scroll reach the bottom of the content in containing element 112, the steps 270 and 272 of pinning the shorter content containing element while continuing to scroll the longer content containing element are performed as described above.

In general, in the embodiments shown in FIGS. 11 through 14, anytime the containing elements 112 and 114 scroll sufficiently downward to the point where the bottom of the shorter content containing element is reached, the shorter content containing element will be pinned while the longer content containing element continues to scroll upward or downward on an upward or downward scroll event (SD_{S} is less than SD_{L}). However, anytime the containing elements 112 and 114 are near the top of their content so that the bottom of the smaller content containing element has not been reached (SD_{S} is not less than SD_{L}), the containing elements 112 and 114 will scroll upward or downward together in a linked fashion upon an upward or downward scroll event.

Embodiments of a scrolling engine and a resize engine have been described above. It is understood that these software components may operate independently of each other and may be called by an application program separately or together.

Those of skill in the art will appreciate other modes of operation according to the principles of the present system. For example, instead of the smaller content containing element getting pinned when it reaches the bottom of its content, the smaller content containing element may be pinned at the top of its content while the longer content containing element is scrolled per a scroll event. At some point, when the longer content containing element nears the bottom of its content, the two containing elements 112 and 114 would scroll upward and downward together in a linked fashion. In a further alternative embodiment, instead of the shorter content containing element getting pinned at its top or bottom during a scroll, the shorter content containing element may scroll at a slower rate than the longer content containing element. For example, if the content in containing element 114 were twice as long as the content in containing element 112, content within containing elements 112 and 114 may scroll upward and downward together, but with the scroll rate through the content of containing element 112 being one-half the scroll rate through the content in containing element 114.

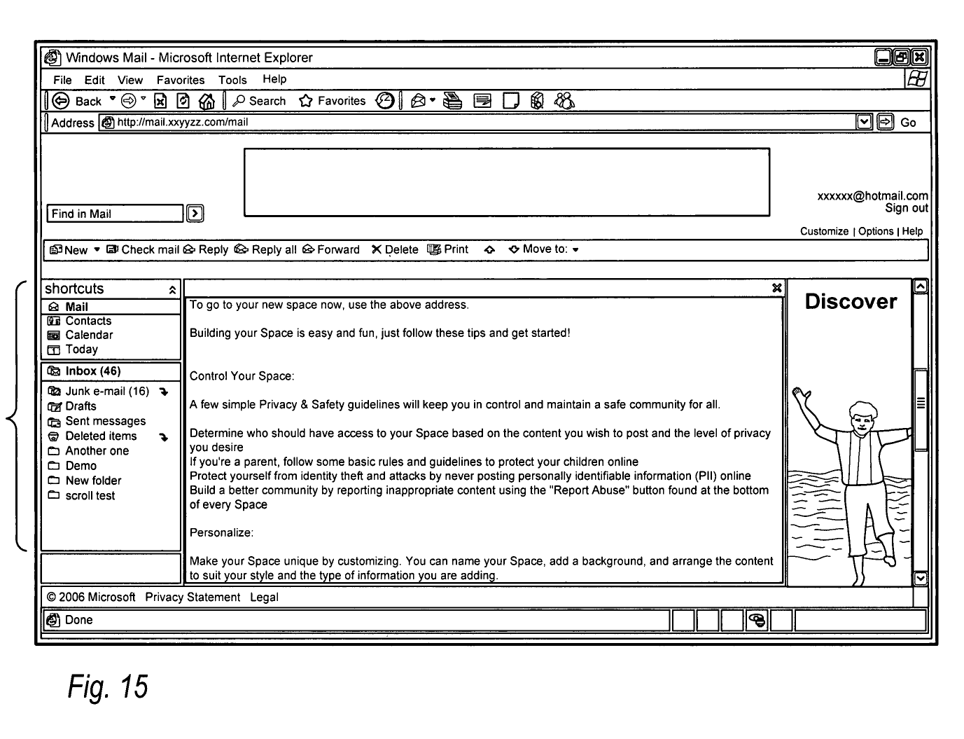

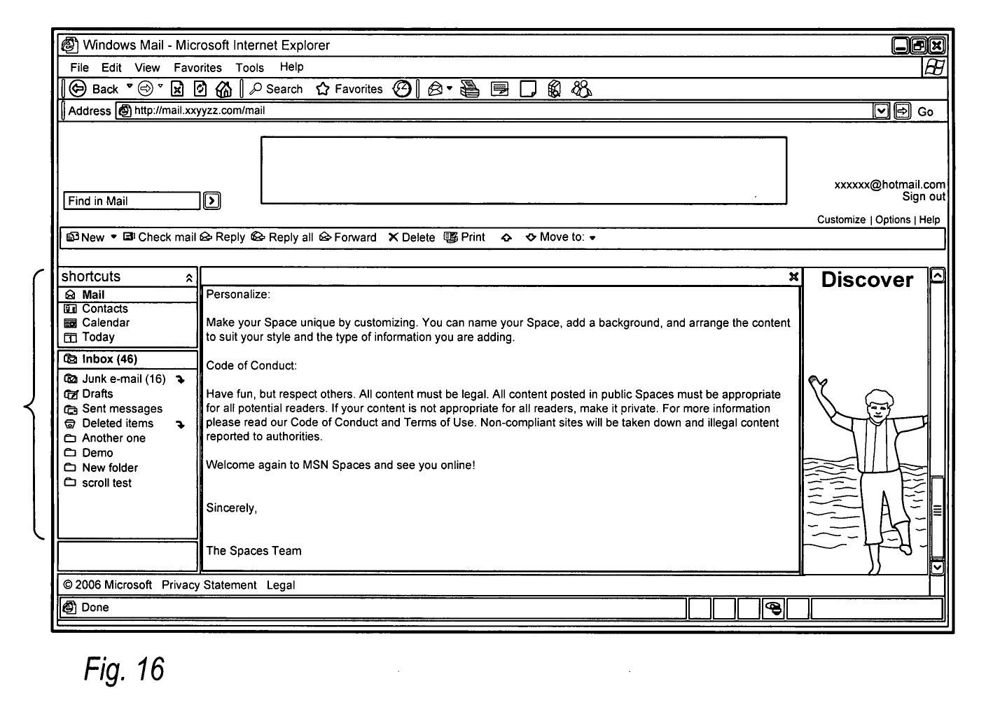

In the above-described embodiments, two containing elements may be linked together for intelligent scrolling through the content of the shorter containing element. For example, where containing element 112 is an advertisement (as in FIGS. 4, 15 and 16), the content within elements 114 and 112 may be scrolled together from the position shown in FIG. 4 until the bottom of the advertisement is reached (the position shown in FIG. 15). Thereafter, continued scrolling through element 114 may occur while content from the advertisement remains fixed and visible on the user interface 110 (as shown in FIG. 16).

While two containing elements have been described as being linked together, it will be appreciated that more than two containing elements may be linked together as described above so that scrolling through the content of the three or more containing elements may occur together. Whenever the bottom of the content in one of the containing elements is reached, that content may be pinned while scrolling may continue through the other containing elements.

In the embodiments described above, the linked containing elements are vertically oriented. In further embodiments, it is understood that horizontal containing elements may be linked for horizontal scrolling as described above. As used herein, the phrase “side-by-side” may imply vertically oriented containing elements or horizontally oriented containing elements. Additionally, the “length” of containing element as used herein may refer to the height of a vertically oriented containing element, or the width of a horizontally oriented containing element. In further embodiments, the containing elements that are linked to each other for intelligent scrolling need not be adjacent to each other, but may be separated by one or more containing elements or other graphical objects on user interface 110.

Furthermore, while the present system has been described with respect to linked scrolling of content provided within containing elements, it is contemplated that the present system may be used for linked scrolling of content that is not provided in containing elements. The content may appear in other graphical objects on a graphical user interface. Moreover, the present system may be used for linked scrolling of first and second contents appearing side-by-side on a graphical user interface whether included within a graphical object or not.

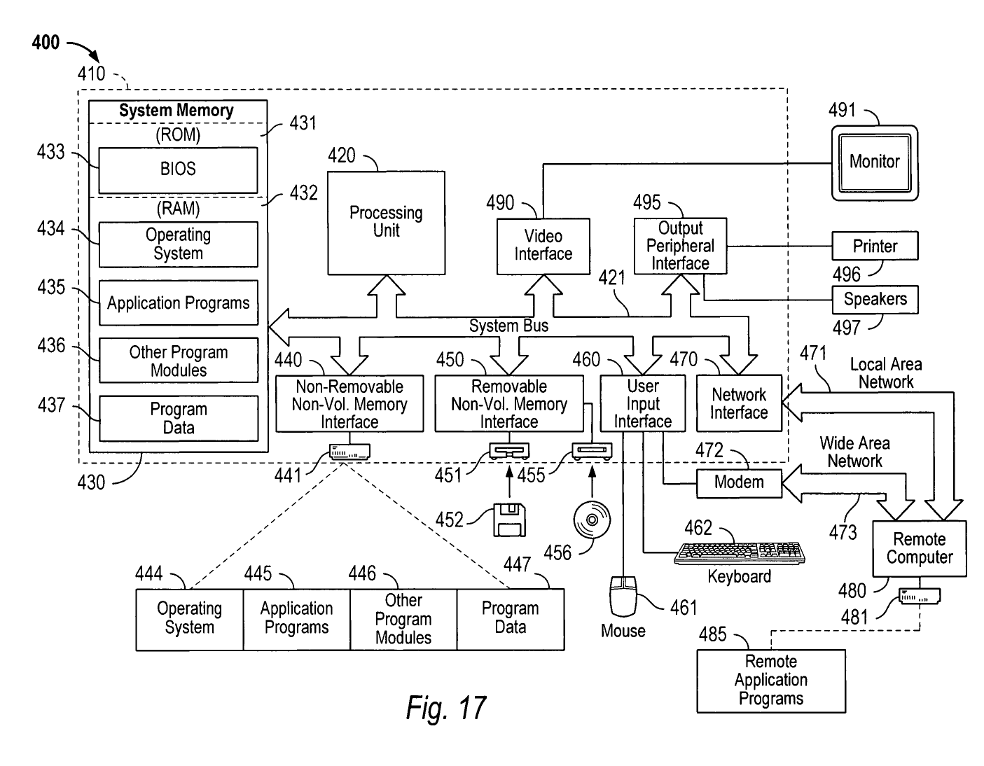

FIG. 17 illustrates an example of a suitable general computing system environment 400 that may comprise any processing device shown herein on which the inventive system may be implemented. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 17, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during startup, is typically stored in ROM 431. RAM 432 typically contains data and/or program modules that are immediately accessible to and/or presently being operated on by processing unit 420. By way of example, and not limitation, FIG. 17 illustrates operating system 434, application programs 435, other program modules 436, and program data 437.

The computer 410 may also include other removable/non-removable, volatile/nonvolatile computer storage media. By way of example only, FIG. 17 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440, magnetic disc drive 451 and optical media reading device 455 are typically connected to the system bus 421 by a removable memory interface, such as interface 450.

The drives and their associated computer storage media discussed above and illustrated in FIG. 17, provide storage of computer readable instructions, data structures, program modules and other data for the computer 410. In FIG. 17, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 17. The logical connections depicted in FIG. 17 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 17 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of controlling a scroll through content within first and second objects on a graphical user interface, the first object having content of a first length and the second object having content of a second length, the second length being a distance x longer than the first length, the method comprising the steps of:
(a) scrolling the content within the first and second objects together when the content in the second object is greater than the distance x from its bottom extent within the second object;
(b) pinning the content within the first object in a fixed position when the content in the second object is less than the distance x from its bottom extent within the second object; and
(c) scrolling the content in the second object by itself, with the content in the first object pinned, when the content in the second object is less than the distance x from its bottom extent within the second object.

2. A method as recited in claim 1, wherein said step (a) of scrolling the content within the first and second objects together and said step (c) of scrolling the content in the second object by itself, with the content in the first object pinned occur during a single scroll event.

3. A method as recited in claim 1, wherein said step (a) of scrolling the content within the first and second objects together and said step (c) of scrolling the content in the second object by itself, with the content in the first object pinned occur during different scroll events.

4. A method as recited in claim 1, wherein said step (a) of scrolling the content within the first and second objects together comprises the step of scrolling the content within the first and second objects in unison the same distance and at the same rate.

5. A method as recited in claim 1, wherein said step (a) of scrolling the content within the first and second objects together comprises the step of performing a scrolling event in the second object.

6. A method as recited in claim 5, wherein said step of performing a scrolling event in the second object comprises the step of scrolling with a mouse while a screen cursor is positioned within the second object.

7. A method as recited in claim 5, wherein said step of performing a scrolling event in the second object comprises the step of scrolling with a keyboard while a screen cursor is positioned within the second object.

8. A method as recited in claim 1, further comprising the steps of:
(d) generating a managed scrollbar for scrolling through the content in the first and second objects by the steps of:
(d1) defining a third object having a length of at least one of the first and second objects,
(d2) defining a fourth object within the third object, the fourth object having a length equal to the length of the content in the second object, and
(d3) providing a scrollbar within the third object for scrolling along the length of the fourth object within the third object; and
(e) displaying the managed scrollbar generated in said step (d).

9. A method as recited in claim 8, further comprising the steps of suppressing the display of separate scrollbars for the contents within the first and second objects.

10. A method as recited in claim 8, wherein said step (a) of scrolling the content within the first and second objects together comprises the step of scrolling using the managed scrollbar generated in said step (d).

11. A method as recited in claim 10, wherein said step of scrolling using the managed scrollbar generated in said step (d) comprises the step of clicking on and dragging a slider in the managed scrollbar.

12. A method as recited in claim 10, wherein said step of scrolling using the managed scrollbar generated in said step (d) comprises the step of clicking on an arrow at the top or bottom of the managed scrollbar.

13. A method as recited in claim 1, wherein the first and second objects comprise two of a larger plurality of objects aligned side-by-side to each other on the graphical user interface, the method further comprising the steps of:
(a) resizing a width of an object of the plurality of objects; and
(b) resizing the second object to a width equal to the combined width of the plurality of objects minus the combined width of the resized objects without the second object.

14. A computer implemented method of controlling a scroll through content within first and second objects on a graphical user interface, the first object having content of a first length and the second object having content of a second length, the second length being a distance x longer than the first length, the method comprising the steps of:
(a) pinning the content within the first object in a fixed position when the content in the second object is less than the distance x from its initial position within the second object;
(b) scrolling the content in the second object by itself, with the content in the first object pinned, when the content in the second object is less than the distance x from its initial position within the second object; and
(c) scrolling the content within the first and second objects together in unison when the content in the second object is greater than the distance x from its initial position within the second object.

15. A method as recited in claim 14, further comprising the steps of:
(d) generating a managed scrollbar for scrolling through the content in the first and second objects by the steps of:
(d1) defining a third object having a length of at least one of the first and second objects,
(d2) defining a fourth object within the third object, the fourth object having a length equal to the length of the content in the second object, and
(d3) providing a scrollbar within the third object for scrolling along the length of the fourth object within the third object; and
(e) displaying the managed scrollbar generated in said step (d).

16. A method as recited in claim 15, wherein said step (a) of scrolling the content within the first and second objects together in unison comprises the step of scrolling using the managed scrollbar generated in said step (d).

17. In a computer system having a graphical user interface including a display and a user interface selection device, a method of controlling a scroll through content within first and second containing elements on the graphical user interface, the first containing element having an advertisement of a first length and the second containing element having content of a second length, the second length being a distance x longer than the first length, the method comprising the steps of:
(a) scrolling the advertisement within the first containing element and the content in the second containing element together when the content in the second containing element is greater than the distance x from its bottom extent within the second containing element;
(b) pinning the advertisement within the first containing element in a fixed position when the content in the second containing element is less than the distance x from its bottom extent within the second containing element; and
(c) scrolling the content in the second containing element by itself, with the advertisement in the first containing element pinned, when the content in the second containing element is less than the distance x from its bottom extent within the second containing element.

18. A method as recited in claim 17, further comprising the steps of:
(d) generating a managed scrollbar for scrolling through the content in the first and second containing elements by the steps of:
(d1) defining a third containing element having a length of at least one of the first and second containing elements,
(d2) defining a fourth containing element within the third containing element, the fourth containing element having a length equal to the length of the content in the second containing element, and
(d3) providing a scrollbar within the third containing element for scrolling along the length of the fourth containing element within the third containing element; and
(e) displaying the managed scrollbar generated in said step (d).

19. A method as recited in claim 18, wherein the first and second containing elements comprise two of a larger plurality of containing elements aligned side-by-side to each other on the graphical user interface, the method further comprising the steps of:
(f) resizing a width of a containing element of the plurality of containing elements;
(g) resizing the second containing element to a width equal to the combined width of the plurality of containing elements minus the combined width of the resized containing elements without the second containing element.

20. A method as recited in claim 17, the second containing element further including a nested containing element within the second containing element, the method further comprising the steps of:
(d) resizing a lower horizontal boundary of the nested containing element to be coextensive with a lower horizontal boundary of the second containing element;
(e) displaying a horizontal scrollbar of the nested containing element at a bottom of the second containing element.
